(19) United States
(12) Patent Application Publication
(10) Pub. No.: US 2021/0371011 A1
(43) Pub. Date: Dec. 2, 2021

(54) ELECTRIC POWERED VEHICLE

(71) Applicants: TOYOTA JIDOSHA KABUSHIKI KAISHA, Toyota-shi (JP); SUBARU CORPORATION, Tokyo (JP)

(72) Inventors: Keisuke ITOH, Nagoya-shi (JP); Junya OKAMURA, Shibuya-ku (JP); Tomohiro MATSUMOTO, Shibuya-ku (JP)

(73) Assignees: TOYOTA JIDOSHA KABUSHIKI KAISHA, Toyota-shi (JP); SUBARU CORPORATION, Tokyo (JP)

(21) Appl. No.: 17/245,321

(22) Filed: Apr. 30, 2021

(30) Foreign Application Priority Data
Jun. 2, 2020 (JP) 2020-096045

(51) Int. Cl. B62D 21/15; B60K 1/04; H01M 50/249; H01M 50/291; H01M 50/244; H01M 50/242

(52) U.S. Cl. CPC B62D 21/152; B60K 1/04; H01M 50/249; H01M 50/291; B62D 25/20; H01M 50/242; B60K 2001/0438; H01M 2220/20; H01M 50/244

(57) ABSTRACT

An electric powered vehicle may include a floor panel; a battery case located below the floor panel and housing a battery therein; a rear side member located rearward of the battery case, protruding downward from the floor panel, and extending along a front-rear direction of the electric powered vehicle; and a bracket in contact with and fixed to the battery case, the bracket being in contact with and fixed to the rear side member.

### CROSS-REFERENCE TO RELATED APPLICATION

This application claims priority to Japanese Patent Application No. 2020-096045 filed on Jun. 2, 2020, the contents of which are hereby incorporated by reference into the present application.

### TECHNICAL FIELD

The art disclosed herein relates to an electric powered vehicle. In the disclosure herein, an electric powered vehicle refers to a vehicle configured to travel by using electric power stored in a battery. The electric powered vehicle may include an electric vehicle, a hybrid vehicle, and a fuel cell vehicle.

### BACKGROUND

Japanese Patent Application Publication No. 2019-038403 describes an electric powered vehicle having a battery case below a floor panel. Further, this electric powered vehicle includes a pair of rear side members (also called rear side frames) and a rear crossmember rearward of the battery case. Each of the rear side members protrudes downward from the floor panel. Each of the rear side members extends along a front-rear direction of the electric powered vehicle. The rear side members are spaced from each other along a width direction of the electric powered vehicle. The rear crossmember protrudes downward from the floor panel. The rear crossmember extends along the width direction and connects the rear side members to each other. This electric powered vehicle further includes a plurality of brackets. A rear end of each bracket is connected to the rear crossmember. A front end of each bracket is connected to the battery case. By connecting the rear crossmember and the battery case with the brackets as above, a collision load applied upon a collision to the electric powered vehicle can be transmitted to the battery case, by which body deformation can be diminished.

### SUMMARY

Upon a rear-end collision to an electric powered vehicle (collision to a rear portion of the electric powered vehicle), a high load is applied to its rear side members. In the electric powered vehicle of Japanese Patent Application Publication No. 2019-038403, the rear side members are connected to the brackets via the rear crossmember. Thus, the load tends not to be transmitted to the brackets and the battery case from the rear side members upon a rear-end collision. As a result, one or both of the rear side members could be deformed by the load and the deformed rear side member(s) could enter between the floor panel and the battery case. When the rear side member(s) is deformed as above, the deformed rear side member(s) collides into an upper surface of the battery case. Since the upper surface of the battery case is normally covered by the floor panel, the upper surface of the battery case does not have high mechanical strength. Thus, if the deformed rear side member(s) collides into the upper surface of the battery case, batteries inside the battery case may be damaged. The disclosure herein proposes a technique that enables deformation of a rear side member to be effectively diminished upon a rear-end collision.

An electric powered vehicle disclosed herein may comprise a floor panel, a battery case, a rear side member, and a bracket. The battery case may be located below the floor panel and house a battery therein. The rear side member may be located rearward of the battery case, protrude downward from the floor panel, and extend along a front-rear direction of the electric powered vehicle. The bracket may be in contact with and fixed to the battery case. The bracket may also be in contact with and fixed to the rear side member.

In this electric powered vehicle, the bracket is directly fixed to the rear side member. Thus, a load applied to the rear side member upon a rear-end collision tends to be transmitted to the battery case through the bracket. According to this, the battery case and the bracket ensure support of the rear side member, and deformation of the rear side member can effectively be diminished. Therefore, it is possible to prevent the rear side member from entering between the floor panel and the battery case and colliding with an upper surface of the battery case, and thus damage to the battery can be prevented.

### BRIEF DESCRIPTION OF DRAWINGS

FIG. 1 is a perspective view of a body of an electric powered vehicle;

FIG. 2 is a bottom plan view of a rear portion of the body of the electric powered vehicle;

FIG. 3 is a bottom oblique view of the rear portion of the body of the electric powered vehicle;

FIG. 4 is a cross-sectional view of the body of the electric powered vehicle along a width direction of the electric powered vehicle;

FIG. 5 is an enlarged view of a bracket;

FIG. 6 is a cross-sectional view of the body of the electric powered vehicle along a front-rear direction of the electric powered vehicle; and

FIG. 7 is a cross-sectional view exemplifying deformation of a bracket and a rear side member of an electric powered vehicle according to a comparative example upon a rear-end collision.

### DETAILED DESCRIPTION

Some of the features characteristic to the electric powered vehicle disclosed herein will be listed. It should be noted that the respective technical elements are independent of one another, and are useful solely or in combinations.

In an example of the electric powered vehicle disclosed herein, the bracket may comprise a first portion in contact with and fixed to a lower surface of the battery case; and a second portion in contact with and fixed to a rear side surface of the battery case. According to this configuration, the bracket is less likely to be detached from the battery case upon a rear-end collision.

In an example of the electric powered vehicle disclosed herein, the second portion of the bracket may cover an end portion of the rear side surface in a width direction of the electric powered vehicle.

The end portion of the battery case in the width direction has high strength against a load applied in a front-rear direction of the electric powered vehicle. When the second portion of the bracket covers the end portion of the rear side surface of the battery case in the width direction as above, a load tends to be transmitted, upon a rear-end collision, to the end portion of the battery case in the width direction through the bracket, as a result of which the battery case is less likely to deform.

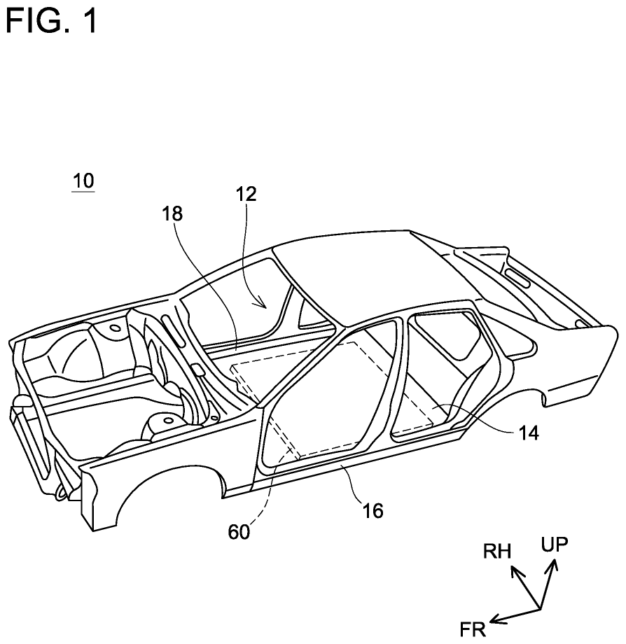

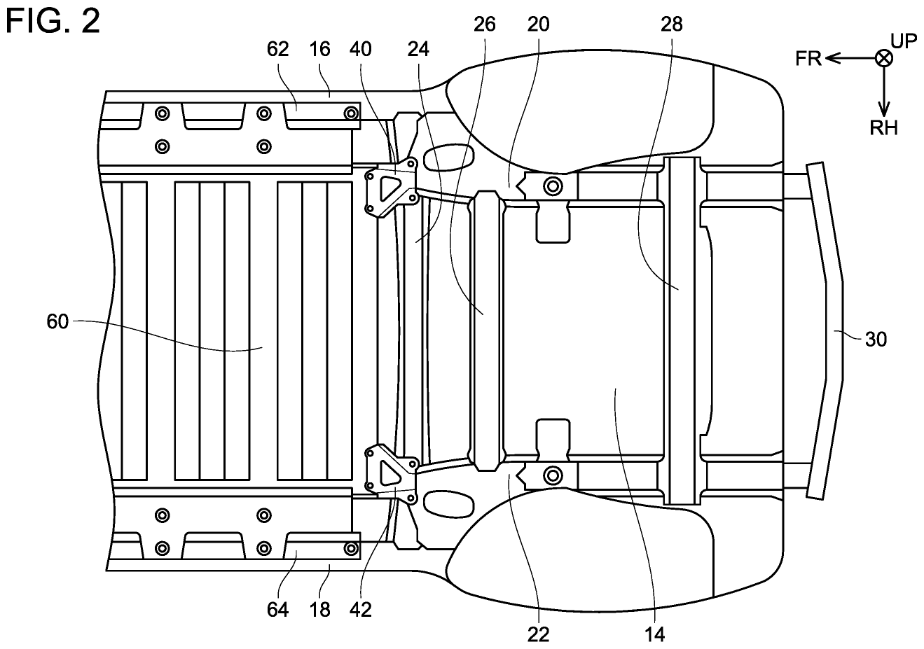

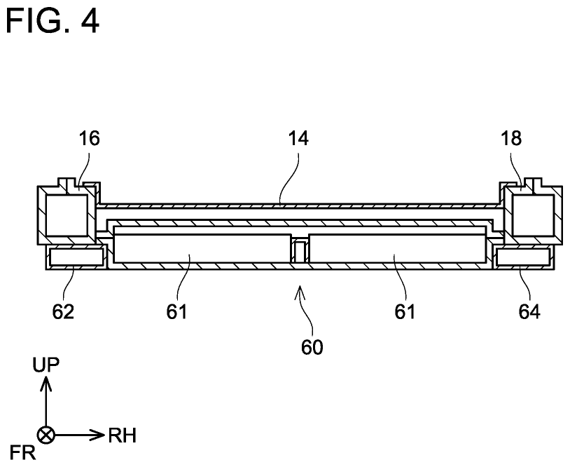

FIG. 1 is a perspective view of a body of an electric powered vehicle 10 according to an embodiment. In the drawings including FIG. 1, an arrow FR indicates a front direction of the electric powered vehicle, an arrow RH indicates a right direction of the electric powered vehicle, and an arrow UP indicates an upward direction of the electric powered vehicle. As shown in FIG. 1, the electric powered vehicle 10 includes a floor panel 14 that configures a floor of a passenger compartment 12. A battery case 60 is disposed below the floor panel 14. Rockers 16, 18 are fixed to the floor panel 14. The rocker 16 is fixed to a left edge of the floor panel 14 and extends long in a front-rear direction of the electric powered vehicle. The rocker 18 is fixed to a right edge of the floor panel 14 and extends long in the front-rear direction. As shown in FIGS. 2 and 4, the battery case 60 is disposed between the rocker 16 and the rocker 18. A mounting member 62 is disposed below the rocker 16. The mounting member 62 is disposed leftward of the battery case 60. The battery case 60 is fixed to the rocker 16 via the mounting member 62. A mounting member 64 is disposed below the rocker 18. The mounting member 64 is disposed rightward of the battery case 60. The battery case 60 is fixed to the rocker 18 via the mounting member 64. As shown in FIG. 4, a plurality of battery cells 61 is disposed within the battery case 60. Each of the battery cells 61 is configured to supply electric power to a motor (not shown). This motor rotates wheels of the electric powered vehicle 10, and thereby the electric powered vehicle 10 travels.

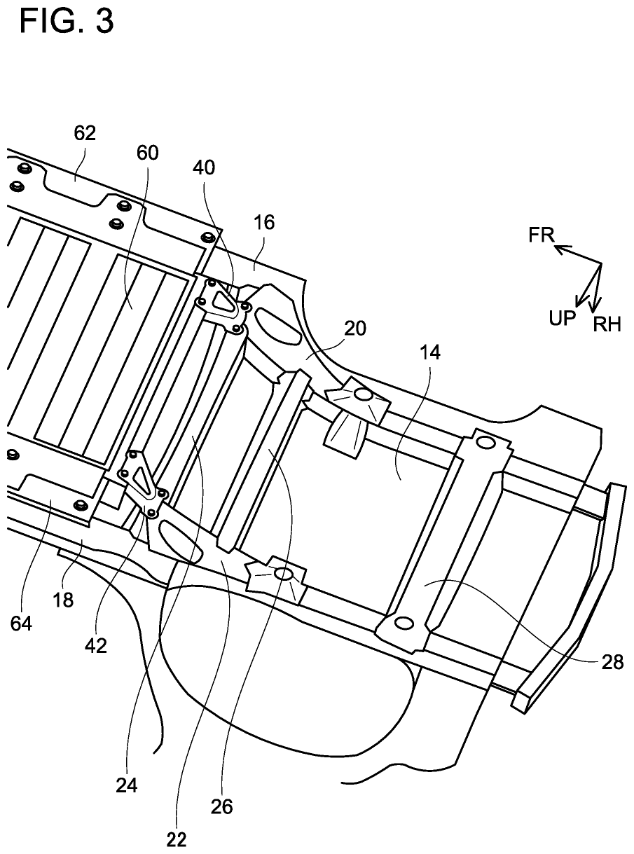

As shown in FIGS. 2 and 3, a rear crossmember 24 is disposed rearward of the battery case 60. The rear crossmember 24 is fixed to the floor panel 14 by welding or the like. The rear crossmember 24 protrudes downward from the floor panel 14. The rear crossmember 24 extends long along the width direction. A left end of the rear crossmember 24 is fixed to the rocker 16 by welding or the like. A right end of the rear crossmember 24 is fixed to the rocker 18 by welding or the like.

A pair of rear side members 20, 22 is disposed rearward of the rear crossmember 24. The rear side members 20, 22 are fixed to the floor panel 14 by welding or the like. The rear side members 20, 22 protrude downward from the floor panel 14. The rear side member 20 is disposed along the left edge of the floor panel 14 and extends long in the front-rear direction. A front end of the rear side member 20 is fixed to the rear crossmember 24 by welding or the like. A rear end of the rear side member 20 is connected to a bumper reinforcement 30 at a rear end of the body. The rear side member 22 is disposed along the right edge of the floor panel 14 and extends long in the front-rear direction. A front end of the rear side member 22 is fixed to the rear crossmember 24 by welding or the like. A rear end of the rear side member 22 is connected to the bumper reinforcement 30 at the rear end of the body.

A rear crossmember 26 is disposed rearward of the rear crossmember 24. The rear crossmember 26 is fixed to the floor panel 14 by welding. The rear crossmember 26 protrudes downward from the floor panel 14. The rear crossmember 26 extends long in the width direction. A left end of the rear crossmember 26 is fixed to the rear side member 20 by welding or the like. A right end of the rear crossmember 26 is fixed to the rear side member 22 by welding or the like.

A rear crossmember 28 is disposed rearward of the rear crossmember 26. The rear crossmember 28 is fixed to the floor panel 14 by welding. The rear crossmember 28 protrudes downward from the floor panel 14. The rear crossmember 28 extends long in the width direction. A left end of the rear crossmember 28 is fixed to the rear side member 20 by welding or the like. A right end of the rear crossmember 28 is fixed to the rear side member 22 by welding or the like.

Brackets 40, 42 are disposed below the floor panel 14. The bracket 40 connects the battery case 60 to the rear side member 20. The bracket 42 connects the battery case 60 to the rear side member 22.

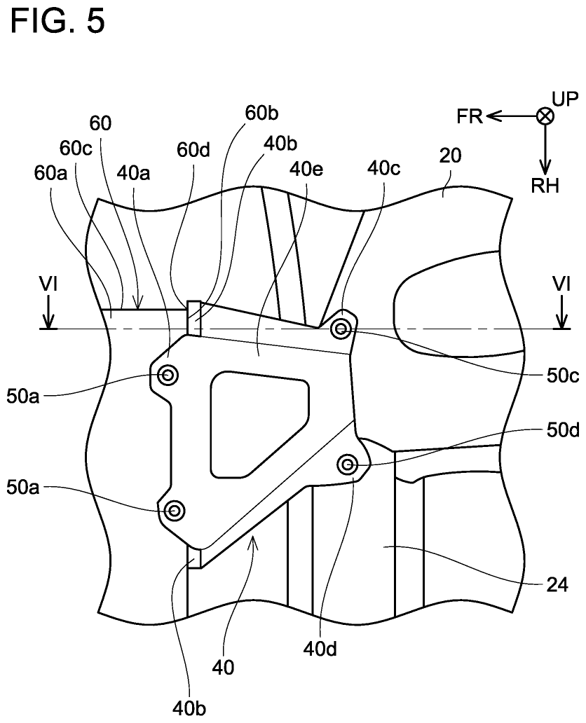

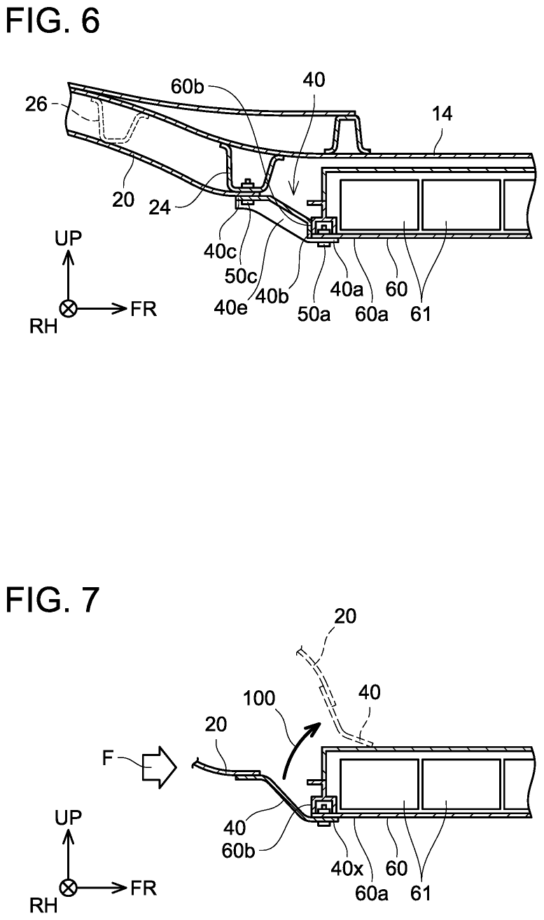

FIG. 5 is an enlarged view of the bracket 40. Further, FIG. 6 is a cross-sectional view of the body along a line passing through the bracket 40 (a cross-sectional view along a line VI-VI of FIG. 5). As shown in FIGS. 5 and 6, the bracket 40 includes a first portion 40a covering a lower surface 60a of the battery case 60, a second portion 40b covering a rear side surface 60b of the battery case 60, a third portion 40c covering a lower surface of the rear side member 20, a fourth portion 40d covering a lower surface of the rear crossmember 24, and a connecting portion 40e connecting the first portion 40a, the second portion 40b, the third portion 40c, and the fourth portion 40d to each other.

The first portion 40a is in contact with the lower surface 60a of the battery case 60. The first portion 40a is fixed to the lower surface 60a of the battery case 60 with two bolts 50a. The second portion 40b is in contact with the rear side surface 60 of the battery case 60. The second portion 40b is fixed to the rear side surface 60b of the battery case 60 by welding or bolts (not shown). As shown in FIG. 6, the second portion 40b is connected to the first portion 40a. A mounting portion that is bent in an L shape is configured by the first portion 40a and the second portion 40b. That is, the L-shaped mounting portion is fixed to the lower surface 60a and the rear side surface 60b of the battery case 60.

As shown in FIGS. 5 and 6, the connecting portion 40e extends rearward from the first portion 40a and the second portion 40b. The third portion 40c and the fourth portion 40d are disposed at a rear portion of the connecting portion 40e.

The third portion 40c is in contact with the lower surface of the rear side member 20. More specifically, the third portion 40c is in contact with the lower surface of a portion of the rear side member 20 that covers the lower surface of the rear crossmember 24. The third portion 40c is fixed to the rear side member 20 and the rear crossmember 24 with a bolt 50c. The fourth portion 40d is in contact with the lower surface of the rear side member 24. The fourth portion 40d is fixed to the rear crossmember 24 with a bolt 50d.

As shown in FIGS. 2 and 3, the bracket 42 has substantially the same configuration as the bracket 40. That is, an L-shaped mounting portion is provided at a front end of the bracket 42. The L-shaped mounting portion is fixed to the lower surface 60a and the rear side surface 60b of the battery case 60. A rear end of the bracket 42 is fixed to the rear side member 22 and the rear crossmember 24.

Next, functions of the bracket 40 will be described. When a rear-end collision occurs to the electric powered vehicle 10, a load is transmitted from the bumper reinforcement 30 at the rear end of the body to the rear side members 20, 22. The load transmitted to the rear side member 20 is transmitted to the rocker 16 and also to the battery case 60 through the bracket 40. The load transmitted to the rear side member 22 is transmitted to the rocker 18 and also to the battery case 60 through the bracket 42. In this way, in the electric powered vehicle 10, the load applied to the rear side members 20, 22 can be received not only by the rockers 16, 18 but also by the battery case 60. Since the rear side members 20, 22 can be supported not only by the rockers 16, 18 but also by the battery case 60, significant forward deformation of the rear side members 20, 22 can be diminished. Especially, the bracket 40 is directly fixed to the rear side member 20 and the battery case 60 in the electric powered vehicle 10, and therefore the load tends to transmit from the rear side member 20 to the battery case 60. Further, since the bracket 42 is directly fixed to the rear side member 22 and the battery case 60, the load tends to transmit from the rear side member 22 to the battery case 60. Thus, deformation of the rear side members 20, 22 can be effectively diminished. For example, it is possible to prevent the rear side members 20, 22 from breaking off from the rockers 16, 18, and thereby it is possible to prevent the front ends of the rear side members 20, 22 from entering between the floor panel 14 and the battery case 60. Thus, it is possible to prevent the rear side members 20, 22 from colliding into an upper surface of the battery case 60 and damaging the battery cells 61. Further, since the load can be distributed to the rockers 16, 18 and the battery case 60 below the passenger compartment 12 as described above, deformation of the passenger compartment 12 can be diminished.

Further, in the electric powered vehicle 10 according to the present embodiment, the bracket 40 is fixed to both the lower surface 60a and the rear side surface 60b of the battery case 60, and thus the battery cells 61 are less likely to be damaged. FIG. 7 shows, as a comparative example, a configuration in which the bracket 40 is fixed to the lower surface 60a of the battery case 60 but is not fixed to the rear side surface 60b of the battery case 60. In this configuration, when a load F is applied to the rear side member 20 by a rear-end collision, the bracket 40 breaks and the rear side member 20 and the bracket 40 may be thereby deformed and displaced to a position above the battery case 60 as shown by an arrow 100. When such deformation occurs, the bracket 40 and/or the rear side member 20 may collide into the upper surface of the battery case 60. In the course of such deformation, firstly, a front end 40x of the bracket 40 is temporarily pulled rearward in response to the rear side member 20 deforming upward, and shearing stress is applied to a fixed portion (e.g., a bolt) between the front end 40x and the battery case 60. When such shearing stress is applied, the fixed portion between the front end 40x and the battery case 60 breaks, and the entirety of the bracket 40 and the rear side member 20 are displaced upward. Contrary to this, in the electric powered vehicle 10 according to the embodiment, as shown in FIG. 6, the bracket 40 includes the second portion 40b fixed to the rear side surface 60b of the battery case 60 as well as the first portion 40a fixed to the lower surface 60a of the battery case 60. When shearing stress is applied to a fixed portion between the first portion 40a and the battery case 60 due to a rear-end collision, tensile stress is applied to a fixed portion between the second portion 40b and the battery case 60. Each of these fixed portions have relatively high strength against tensile stress. Therefore, the bracket 40 is less likely to break, and the bracket 40 and the rear side member 20 are less likely to be displaced upward. Thus, in the electric powered vehicle 10 according to the embodiment, the battery cells 61 are less likely to be damaged. By fixing the bracket 40 to two surfaces of the battery case 60 as above, it is possible to prevent application of shearing stress to both of the fixed portions, and thereby breakage of the bracket 40 can be prevented. In the foregoing description, the bracket 40 has been described as an example, however, the bracket 42 functions in the same manner.

Further, as shown in FIG. 5, in the electric powered vehicle 10 according to the embodiment, the second portion 40b of the bracket 40 covers a left end portion 60d of the rear side surface 60b of the battery case 60. Thus, a load tends to be transmitted from the bracket 40 to the end portion 60d. A portion of the battery case 60 around the end portion 60d is supported not only by a metal plate constituting the lower surface 60a of the battery case 60 but also by a metal plate constituting a left side surface 60c of the battery case 60, and thus it has high strength against a load applied in the front-rear direction. Therefore, according to this configuration, a higher load can be received by the battery case 60, and thus deformation of the rear side member 20 can be more suitably diminished. In the foregoing description, the bracket 40 has been described as an example, however, the bracket 42 functions in the same manner.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. An electric powered vehicle, comprising:
a floor panel;
a battery case located below the floor panel and housing a battery therein;
a rear side member located rearward of the battery case, protruding downward from the floor panel, and extending along a front-rear direction of the electric powered vehicle; and
a bracket in contact with and fixed to the battery case, the bracket being in contact with and fixed to the rear side member.

2. The electric powered vehicle of claim 1, wherein
the bracket comprises:
a first portion in contact with and fixed to a lower surface of the battery case; and
a second portion in contact with and fixed to a rear side surface of the battery case.

3. The electric powered vehicle of claim 2, wherein the second portion of the bracket covers an end portion of the rear side surface in a width direction of the electric powered vehicle.
